(19) United States
(12) Patent Application Publication
(10) Pub. No.: US 2013/0339978 A1
(43) Pub. Date: Dec. 19, 2013

(54) LOAD BALANCING FOR HETEROGENEOUS SYSTEMS

(71) Applicant: Advanced Micro Devices, Inc., Sunnyvale, CA (US)

(72) Inventor: Benjamin T. Sander, Austin, TX (US)

(21) Appl. No.: 13/917,484

(22) Filed: Jun. 13, 2013

Related U.S. Application Data
(60) Provisional application No. 61/659,173, filed on Jun. 13, 2012.

(51) Int. Cl. G06F 9/50

(52) U.S. Cl. CPC G06F 9/505; G06F 9/5094
USPC 718/105

(57) ABSTRACT

A method and an apparatus for performing load balancing in a heterogeneous computing system including a plurality of processing elements are presented. A program places tasks into a queue. A task from the queue is distributed to one of the plurality of processing elements, wherein the distributing includes the one processing element sending a task request to the queue and receiving a task to be done from the queue. The task is performed by the one processing element. A result of the task is sent from the one processing element to the program. The load balancing is performed by distributing tasks from the queue to processing elements that complete the tasks faster.

### CROSS REFERENCE TO RELATED APPLICATIONS

This application claims the benefit of U.S. Provisional Application No. 61/659,173, filed on Jun. 13, 2012, the contents of which are hereby incorporated by reference as if fully set forth herein.

### TECHNICAL FIELD

The disclosed embodiments are generally directed to heterogeneous computing systems, and in particular, to performing load balancing on such systems.

### BACKGROUND

In some implementations of a heterogeneous computing system, the central processing unit (CPU) and the graphics processing unit (GPU) are physically separate units, and the GPU may be located on a graphics card with its own memory. In this type of configuration, for the CPU and the GPU to share tasks, the data needs to be copied from the CPU's local memory (from the initial dispatch of the tasks) to GPU's local memory (for example, on the graphics card) for processing, and then possibly copied back to the CPU's local memory for final processing. The time needed to copy the data back and forth between the two memories may overwhelm any performance benefit that could be derived from load balancing the tasks between the CPU and the GPU. This is referred to as the “data placement problem.”

Other implementations of a heterogeneous computing system utilize an accelerated processing unit (APU), which places the CPU and the GPU on the same die. This configuration allows both the CPU and the GPU to access the same memory (located on the die) without the need for copying the data, thereby architecturally eliminating the data placement problem, which creates more possibilities for load balancing.

### SUMMARY OF EMBODIMENTS

Some embodiments provide a method for performing load balancing in a heterogeneous computing system including a plurality of processing elements. A program places tasks into a queue. A task from the queue is distributed to one of the plurality of processing elements, wherein the distributing includes the one processing element sending a task request to the queue and receiving a task to be done from the queue. The task is performed by the one processing element. A result of the task is sent from the one processing element to the program. The load balancing is performed by distributing tasks from the queue to processing elements that complete the tasks faster.

Some embodiments provide a heterogeneous computing system configured to perform load balancing. The system includes a plurality of processing elements and a queue. The queue is configured to hold tasks placed in the queue by a program and distribute a task to one of the plurality of processing elements, wherein the distributing includes the one processing element sending a task request to the queue and receiving a task to be done from the queue. Each of the plurality of processing elements is configured to perform the task and send a result of the task to the program. The load balancing is performed by distributing tasks from the queue to processing elements that complete the tasks faster.

Some embodiments provide a method for performing load balancing in a heterogeneous computing system including a plurality of processing elements. An algorithm of a program is performed on a first processing element. A utilization value of a second processing element is monitored by the program. A remaining portion of the algorithm is performed on the second processing element when the utilization value of the second processing element is below a threshold, thereby performing load balancing.

Some embodiments provide a method for performing load balancing in a heterogeneous computing system including a plurality of processing elements. An algorithm of a program is performed on all of the plurality of processing elements. An energy consumption value of each of the plurality of processing elements is monitored by the program. A remaining portion of the algorithm is moved to different processing elements when the energy consumption value of one of the plurality of processing elements exceeds a threshold, thereby performing load balancing.

### BRIEF DESCRIPTION OF THE DRAWINGS

A more detailed understanding may be had from the following description, given by way of example in conjunction with the accompanying drawings, wherein:

FIG. 1 is a block diagram of an example device in which one or more disclosed embodiments may be implemented;

FIG. 2 is a block diagram of an exemplary heterogeneous computing system, according to some embodiments;

FIG. 3 is a block diagram of an exemplary system configured to perform load balancing using a single task queue;

FIG. 4 is a flowchart of a method for performing load balancing using a single task queue; and

FIG. 5 is a flowchart of a method for performing load balancing based on energy consumption.

### DETAILED DESCRIPTION

A method and an apparatus for performing load balancing in a heterogeneous computing system including a plurality of processing elements are presented. A program places tasks into a queue. A task from the queue is distributed to one of the plurality of processing elements, wherein the distributing includes the one processing element sending a task request to the queue and receiving a task to be done from the queue. The task is performed by the one processing element. A result of the task is sent from the one processing element to the program. The load balancing is performed by distributing tasks from the queue to processing elements that complete the tasks faster.

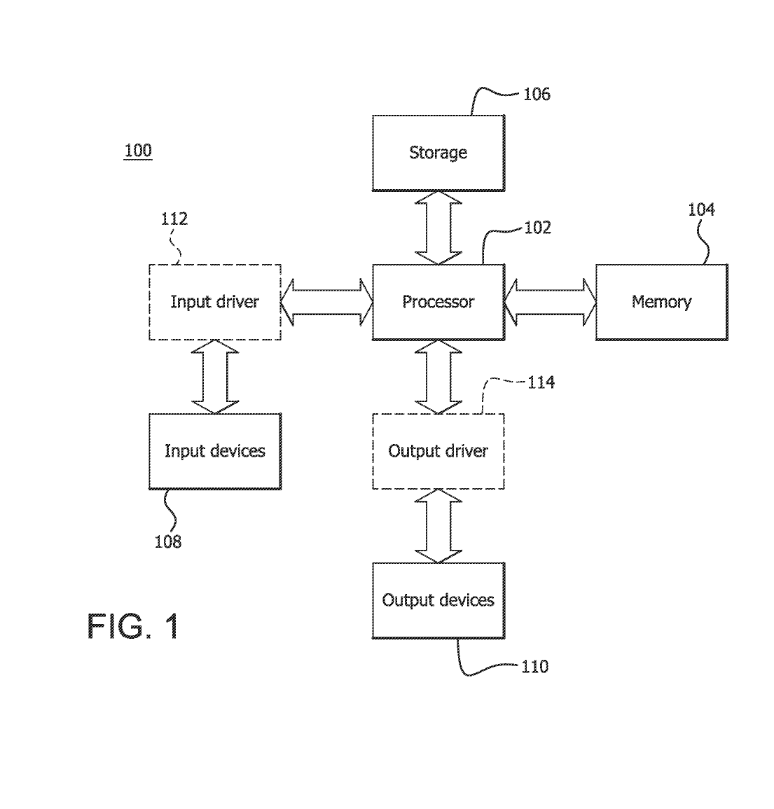

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

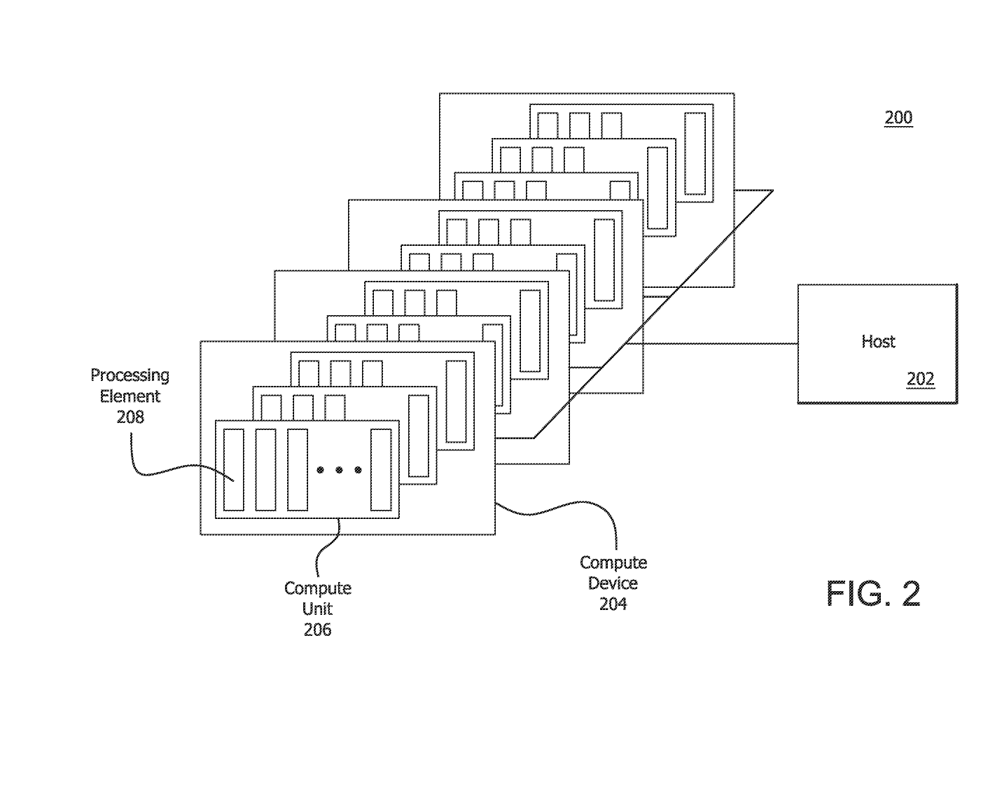

FIG. 2 is a block diagram of an exemplary heterogeneous computing system 200; in this example, the computing system 200 is an OpenCL™ modeled system. It is noted that the embodiments described herein may operate on any heterogeneous computing system, and are not limited to an OpenCL™ system model. The computing system 200 includes a host 202 which communicates with one or more compute devices 204. Each compute device 204 includes one or more compute units 206, and each compute unit 206 includes one or more processing elements 208. It is understood that the computing system 200 may include any number of compute devices 204, compute units 206, and processing elements 208.

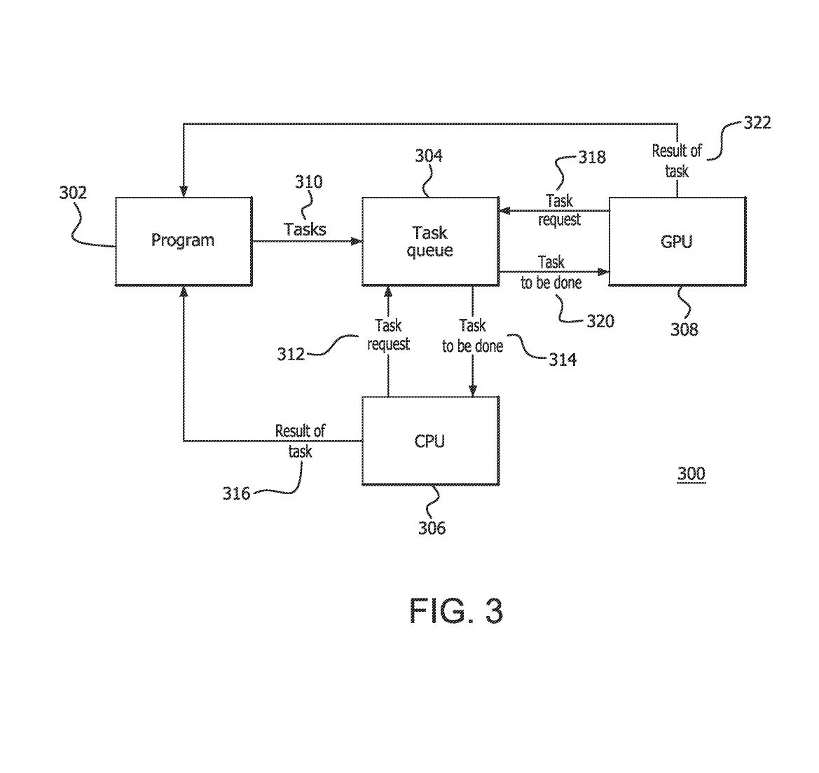

The compute device 204, the compute unit 206, and the processing elements 208 shown in FIG. 2 may be used instead of the processor 102 in FIG. 1 in an embodiment. The heterogeneous computing system 200 is a general description of such a system; the system 300 shown in FIG. 3 is one example implementation of a heterogeneous computing system.

FIG. 3 is a block diagram of a system 300 configured to perform load balancing using a single task queue. The system 300 includes a program 302, a task queue 304, a CPU 306, and a GPU 308. It is noted that the system 300 may include any number of CPUs, GPUs, processing elements, or combinations thereof without altering the operation of the system 300; the load balancing may be performed on any non-CPU processing element. One CPU and one GPU are shown in FIG. 3 for ease of explanation.

The program 302 provides tasks 310 to the task queue 304. The tasks 310 are tasks that the program 302 needs to have performed, and the program 302 does not express a preference for what device processes the tasks 310. When it is available to perform work, the CPU 306 sends a task request 312 to the task queue 304. The task queue 304 responds to the request by sending a task 314 to be done to the CPU 306. Once the CPU 306 has completed the task 314, the CPU 306 sends the result of the task 316 to the program 302. Similarly, when it is available to perform work, the GPU 308 sends a task request 318 to the task queue 304. The task queue 304 responds to the request by sending a task 320 to be done to the GPU 308. Once the GPU 308 has completed the task 320, the GPU 308 sends the result of the task 322 to the program 302.

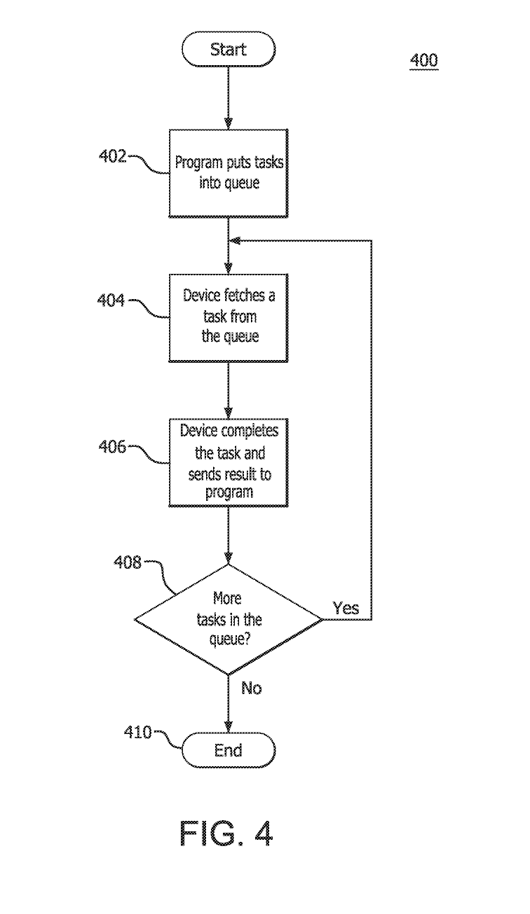

FIG. 4 is a flowchart of a method 400 for performing load balancing using a single task queue. The method 400 begins with a program putting tasks into a task queue (step 402). A device (which may include a CPU, a GPU, or other processing element) fetches a task from the queue (step 404). The fetching may include the device sending a task request to the queue and the queue responding with a task to be done by the requesting device.

The device completes the task and sends the result of the task back to the program (step 406). A determination is made whether there are more tasks in the queue (step 408). If there are more tasks in the queue, then the device fetches another task from the queue (step 404), and the method 400 continues as described above. If there are no more tasks in the queue (step 408), then the method terminates (step 410).

In the embodiments shown in FIGS. 3 and 4, the task queue may include different code representations for the algorithm, one tailored for the GPU and one tailored for the CPU. As an example, a sort algorithm for the GPU may use a parallel radix sort, while a sort algorithm for the CPU may use a quick-sort. In this example, one device (either the GPU or the CPU) executes the entire task, using an algorithm tuned for the specific device. The load balancing occurs when there are multiple tasks available for execution.

As a second example, the task may be expressed as a grid of work groups that may run on either device. The grid may be split and executed on different devices, with each device executing some number of work groups. The load balancing may occur within the task.

Also in the embodiments shown in FIGS. 3 and 4, the runtime may dynamically determine where to execute the code by monitoring the state of the system. In one implementation, the runtime looks at the busyness of the system. All of the tasks are placed into a single queue. Once a device completes its task, it goes back to the queue to fetch the next task in the queue. In this way, the system naturally balances itself, because the devices that complete tasks faster will return to the queue more often. So the devices that are running the fastest may naturally execute more of the tasks from the queue.

In another implementation, the program may indicate a preference for which device (CPU, GPU, or other processing element) processes a given task. This preference may include identifying a specific device, a class of devices (for example, any GPU), or the first available device.

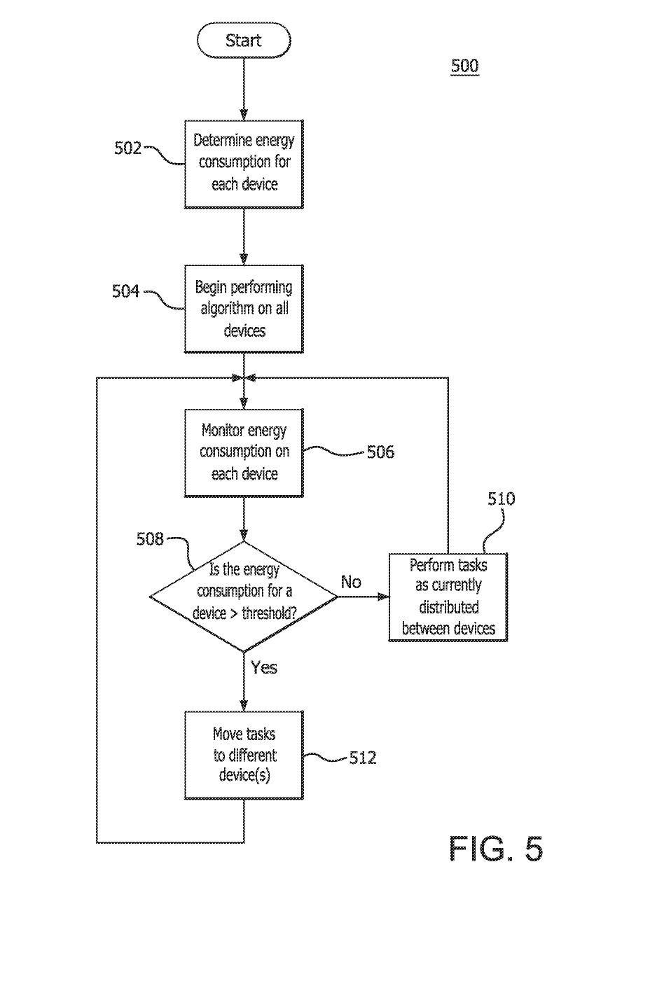

FIG. 5 is a flowchart of a method 500 for performing load balancing based on energy consumption. In the method 500, the runtime uses energy data to determine where to execute the code. The method 500 begins by determining the energy consumption for each device in a system (step 502). It is noted that the devices used by the method 500 may include a CPU, a GPU, or any other processing element. The energy consumption of each device in the system is measured for a known unit of work. Based on this data, the amount of work performed and the amount of energy consumed to perform that work may be determined, along with which device is more efficient at performing a given unit of work. This information, in turn, may be used to make future decisions on where to direct the tasks.

In one implementation, the energy consumption may be measured by running the same task on multiple devices. In another implementation, the energy consumption may be measured for tasks as the run, but without running the same task multiple times. The system then must determine which tasks are approximately equivalent, so that the energy consumption may be compared. The equivalence may be determined, for example, based on input size or performance characteristics of the tasks (for example, cache miss rates).

An algorithm is performed on all devices (step 504). The energy consumption on each device is monitored (step 506) and a determination is made whether the energy consumption for a device is greater than a predetermined threshold (step 508). If the energy consumption is below the threshold, then the tasks are performed as currently distributed between the devices (step 510). The energy consumption on each device is monitored (step 506) as described above. If the energy consumption for a device is greater than the threshold (step 508), then tasks are moved to one or more different devices (step 512). The energy consumption on each device is continuously monitored (step 506) as described above.

Abstraction is used to be able to write a single code base for the heterogeneous system. Using abstraction is beneficial because the programmer only needs to write one code base. The programmer specifies the type of operation, customizes the operation, and the system then builds an optimal algorithm for each available device. For example, in a sort operation, the programmer provides the type of each element to be sorted and the comparison function to be used. The system's runtime component then provides an optimal sort algorithm for the CPU and a different optimal sort algorithm for the GPU, which may be completely different implementations. One way for the system to “build” the optimal algorithm is by using “generic” programming, for example, C++ templates.

The system also automatically performs the load balancing (using one of the approaches described above, for example) instead of requiring the programmer to build the load balancing into the code. Some programming changes may also be implemented, to produce code that is more readily load balanced in a heterogeneous system.

The following examples show how function templates may be used to provide customizable abstract library routines that run efficiently on both CPUs and GPUs. These examples use the C++ (Accelerated Massive Parallelism) programming model. Any programming model that provides generic programming may also provide a similar interface. These function templates may be used to abstract common parallel algorithms. These templates use a simple syntax (resembling the C++ Standard Template Library) and are close to the syntax used on multi-core CPUs. These templates enable sophisticated runtime optimizations behind the scenes. While these templates have been designed to perform well on GPUs, by leveraging sophisticated GPU optimizations like local memory and persistent threads without exposing the associated complexity to the programmer, they also perform well on CPUs.

One example uses a parallel_for_each loop. The following proposed function templates relate to this example.

```
void MatrixMult(float* C, const vector<float>& A,
    const vector<float>& B, int M, int N, int W)
{
array_view<const float,2> a(M,W,A), b(W,N,B);
array_view<writeonly<float>,2> c(M,N,C);
parallel_for_each(c.extents, [=](index<2> idx) mutable restrict(amp)
    {
    float sum = 0;
    for(int i = 0; i < a.x; i++)
      sum += a(idx.y, i) * b(i, idx.x);
    c[idx] = sum;
    }
  );
}
```

One example where this type of loop might be used is in connection with a reduction across a grid (i.e., a sum of differences). As a specific example, this type of loop may be used to reduce an array with 10 million elements to a sum of all elements. While it might be tempting for the programmer to use 10 million separate work items (likely fully occupying the system), most of the communication during this loop occurs in global memory.

A better solution to this problem would be to perform as much reduction as possible within a work item (for example, combining in registers and storing the final value to a local data store). The work items within a work group are combined; the combining is performed in the local data store, and the final value is stored to global memory. Then the work groups are combined into a single final answer, performing the combining in global memory, perhaps on the CPU. The goal with this solution is to launch just enough work groups to keep all of the processing elements busy; for example, four or five work groups for each processing element. It would be desirable to have a programming model abstraction to hide these optimizations from the programmer. An example using such an abstraction may include the following developer code and kernel pseudocode, using a parallel_reduce loop.

Example Developer Code:

```
int SumOfDifferences(const vector<int>& A,
  const vector<int>& B, int W, int H)
{
  array_view<const float,2> a(W,H,A), b(W,H,B);
  combinable<int> result;
  parallel_reduce(a.extents( ), [=](index<2> idx) restrict(amp)
    {
    result.local( ) += a(idx)-b(idx);
    }
  );
  return result.combine( );
}
```

Example Kernel Pseudocode:

```
kernel SumOfDifferences(index<2> wgIdx, extent<2> bound, int *A, int *B,
  int *wgOut int pitch) {
  int resultsLocalGpr = 0;
  local int ldsSum[WG_SIZE];
  for (int i0=wgIdx[0]; i0<wgIdx[0]+bound[0]; i0++) {
    for (int i1=qgIdx[1]; i1<wgIdx[1]+bound[1]; il++) {
      idx = i1*pitch + i0;
      // user lambda function:
      // Note remap results.local( ) to local general purpose register (GPR)
      resultsLocalGpr += A(idx) − B(idx);
    }};
  int lid = get_local_id(0);
  ldsSum[lid] = resultsLocalGpr;
  // reduce across local data store lanes
  if (lid < 32) {
    ldsSum[lid] += ldsSum[lid+32];
  }
  barrier( );
  ...More barrier reductions to get to a single value in ldsSum[0];
  wgOut[get_group_id(0)] = ldsSum[0]; // save result for this work group
};
```

In this kernel, wgIdx indicates a different start point for each work group. The runtime creates GPR for each combinable::local( ) reference. The user lambda function and remapping the results.local are the part of the programmer's kernel; the rest of the code is automatically generated by the runtime.

A second example relates to running a filter on each point in a space (for example, a face detection filter). The filter runs multiple stages of a cascade and can reject a point at any stage. One solution is a GPU-based algorithm using a parallel_for_each loop, which assigns one point to each work item. As points are eliminated from the search, the related work items stop processing useful work. Accordingly, different work items exit the loop at different times, causing poor performance due to divergence.

An optimal solution on the GPU requires the runtime to fill “dead” work items with new points. When a work item exits, assign it a new point from a queue. This may be referred to as a “persistent threads” approach, in which the kernel loops until all work is completed. The runtime can hide the persistent threads from the programmer and can provide better performance by, for example, releasing the processing element at a well-defined boundary. An example of this solution, using a parallel iterative search loop (using a parallel_for_each_iteration construction) follows.

The runtime provides the index point (idx) in the parallel_for_each_iteration loop, while the programmer writes the lambda function for checking one point at a specified iteration.

```
void FaceDetect(const float* image, bool *detectResult,
  int W, int H, const Cascade *cascade)
{
  array_view<const float,2> Image(W, H, image);
  array_view<writeonly<bool>,2> detectResult(M,N,C);
  parallel_for_each_iteration(a.extents( ), [=](index<2> idx, int iter)
  restrict(amp)
  {
  if (iter<cascade->stageCount( ) &&
    (cascade->passFilter(Image, idx, iter))) {
    return True; // keep searching
  } else {
    // Save result:
    detectResult(idx) = (i>=cascade->stageCount( )); //1==survived.
    return False; // Done searching
  }
  }; );
};
```

The following is the kernel pseudocode for the first pass of the face detect algorithm using the parallel_for_each_iteration loop.

```
kernel FaceDetect_FirstPass (..., Rect roi, int stopIteration)
{
  for (int x=roi.left x<roi.right; x++) {
    for (int y=roi.top; y<roi.bottom; y++) {
      index<2> idx(x,y);
      iteration = 0;
      bool keepGoing = True;
        while (iteration<stopIteration && keepGoing) {
        // call the user's lambda function
        keepGoing = _userIterativeSearchFunction(idx, iteration);
        iteration++;
      };
      if (keepGoing) {
        // save (idx,iteration) to queue point
        // queue could be in the local data store or global memory
      };
    };
  }
};
```

Each work group scans a hard-allocated set of points (referred to by the variable “roi”) for a few initial iterations (to the number indicated by the variable “stopIteration”). The survivors of the few initial iterations are saved to the queue for processing by the second pass. It is noted that many queue implementations are possible, and may include for example, a global queue, a partitioned queue, and the like.

The following is the kernel pseudocode for the second pass of the face detect algorithm using the parallel_for_each_iteration loop.

```
kernel FaceDetect_SecondPass (... , int stopIteration)
{
  while (queueNotEmpty) {
    deqItem = remove from queue
    index<2> idx(x,y) = deqItem.idx;
    iteration=0;
    bool keepGoing = True;
    while (iteration<stopIteration && keepGoing) {
      // call the user's lambda function
      keepGoing = _userIterativeSearchFunction(idx, iteration);
      iteration++;
    };
  };
};
```

At the beginning of the first while loop, an element that was saved in the first pass is dequeued. The dequeue mechanics depend on the queue implementation choice. In the userIterativeSearchFunction, the results are saved.

The abstraction layer is applied to the index point and the iteration. When a work item finishes (returns false), the runtime can assign another point and iteration, which solves the divergence issue. Adjacent work items are not required to work on adjacent points, and a work item has no knowledge of the global index position of other work items in the same work group. Thus, the local data store is not generally useful for inter-group communication. This results in a trade-off of a rigid/known work group structure for the benefits of rebalancing.

In this two pass implementation, the first pass includes a hard allocation of work to processing elements, but for limited iterations, and the runtime saves the survivors in a queue. In the second pass, a rebalancing is performed so that each work item has work to do, and the queue is used to keep work items with low iteration counts. The second pass may be performed on the CPU. In analyzing the performance of the face detection algorithm, this type of workload balancing showed promising results.

An alternative example of the kernel pseudocode for the second pass of the face detect algorithm may include a release for a context switch.

```
kernel FaceDetect_SecondPass (... , int stopIteration)
{
  int itemsProcessed = 0;
  while (queueNotEmpty && itemsProcessed<THRESHOLD) {
    itemsProcessed++;
    deqItem = remove from queue
    index<2> idx(x,y) = deqItem.idx;
    iteration=0;
    bool keepGoing = True;
    while (iteration<stopIteration && keepGoing) {
      // call the user's lambda function
      keepGoing = _userIterativeSearchFunction(idx, iteration);
      iteration++;
    };
  };
  // Cleanup queues if needed - ensure saved to global memory
};
```

The first while loop includes a software release of the processing element, which may also be triggered by time or a runtime signal. The queues should be cleaned up upon exiting to provide a clean save-state boundary.

Using the parallel iterative search function template as described above provides a simple abstraction level for programmers. All work items may be represented as an (idx, iteration) tuple, and the programmer only needs to code one iteration of the search algorithm. The runtime optimizations are performed without programmer assistance and include abstraction for persistent threads, rebalancing of the kernels, and performing the processing element (for example, GPU/CPU) workload split. The runtime-initiated soft context switch (as shown in the alternative example of the kernel pseudocode for the second pass) is supported and avoids the issue with other persistent threads solutions.

Another function template may use a parallel_for_each_enq loop. Such a loop may be used in nested parallelism cases where a work item wants to enqueue new work. The new work may be a single work item, as opposed to a grid dispatch approach used with nested parallel_for_each loops. This loop may be used, for example, with target ray-tracing or vision applications.

To implement the parallel_for_each_enq loop, the kernel may call an asynchronous “taskEnqueue” which may use dynamic memory allocation to create a new data item. The kernel places a tuple of (device, kernel, user-defined data pointer) on a queue, and the work represents a single work item (i.e., it does not include any grid dimensions). The runtime is responsible for combining the tuples of work items running on the same kernel into work groups. This may be implemented in a manner similar to the parallel iterative search approach described above, in which the programmer writes a lambda function to process one data item (for example, a ray in a ray-tracing algorithm), and the runtime handles the queue manipulation and assigns work to each work item. Adjacent work items may work on the same instruction stream but unrelated data. This approach may limit the usefulness of the local data store for inter-work group communication similar to the parallel iterative search approach.

A pipeline approach may also be implemented, and may be used to balance the overall workload across the available processing elements in the system. In one implementation, this approach may assume a mix of CPU-only tasks, GPU-only tasks, and CPU or GPU tasks. Pipelining may be used in conjunction with task level parallelism and may be used, for example, in media processing applications. Pipelining may be implemented and built upon existing pipeline structures such as those in ConcRT (Concurrency RunTime) or Intel®'s Threading Building Blocks (TBB). The programmer attaches “filters” or pipe stages and specifies whether the filter can run on the CPU, GPU, or either device. The runtime then balances the workload across all available devices.

Another abstraction type uses the Bolt C++ template library. This library includes routines optimized for common GPU operations and works with existing open standards, such as OpenCL™ and C++ AMP. The routines in this library make GPU programming as easy as CPU programming, by resembling familiar C++ Standard Template Library constructs, being customizable via C++ template parameters, and leveraging high performance shared virtual memory.

The Bolt template library also permits the programmer to supply specific functors (which can also provide device-specific implementations if needed), leverage the C++11 lambda constructs, and supply a kernel in OpenCL™. Direct interfaces to host memory structures are provided, to leverage the heterogeneous system architecture's unified address space and zero-copy memory.

These routines are also optimized for the heterogeneous system architecture by providing a single source code base for the GPU and the CPU and providing platform load balancing, wherein the runtime automatically distributes the workload to the processing elements (CPU, GPU, or both) by using one of the methods described above, for example. With this library, work is submitted to the entire platform rather than to a specific device. The runtime automatically selects the device to process the work item, thereby providing opportunities for load balancing and an optimal CPU path if no GPU is available, for example.

From a performance portability perspective (being able to run the same code base on both the CPU and the GPU with a relatively high level of performance), many algorithms have the same core operation between the CPU and the GPU, with the differences being in how the data is routed to the core operation. By using the Bolt library, the device-specific data routing details are hidden inside the library function implementation. For GPU implementations, this means that the library provides GPU-friendly data strides, the ability to launch a large enough number of threads to hide memory latency, and to provide group memory and work group communication. For CPU implementations, the library provides CPU-friendly data strides and the ability to launch a large enough number of threads to use all available cores.

For heterogeneous system architecture load balancing, the Bolt library provides access to high-performance shared virtual memory, so that programmers do not have to be concerned about data location (i.e., whether the data is located at the device or at the host). The abstractions provided by the Bolt library reside above the level of a kernel launch, such that the programmer does not need to specify the device, the work group shape, the work items, the number of kernels, etc., because the runtime may optimize these parameters for the platform and the available processing elements on which the code is to be executed.

Examples of heterogeneous system architecture load balancing may include, but are not limited to, those shown in Table 1.

TABLE 1

| Example | Description | Exemplary Use Cases |
|---|---|---|
| Data Size | Run large data | Same call-site used |
| | sizes on GPU, | for varying data sizes. |
| | small data sizes on | |
| | CPU. | |
| Reduction | Run initial | Any reduction operation. |
| | reduction phases | |
| | on GPU, run final | |
| | phases on CPU. | |
| Borders | Run wide center | Image processing. Scan |
| | regions on GPU, | implementation. |
| | run border regions | |
| | on CPU. | |
| Platform | Distribute | Kernel has similar performance/ |
| Super-Device | workgroups to | energy on CPU and GPU. |
| | available | |
| | processing units on | |
| | the entire platform. | |
| Heterogeneous | Run a pipelined | Video processing pipeline. |
| Pipeline | series of user- | |
| | defined stages. | |
| | Stages can be CPU- | |
| | only, GPU-only, or | |
| | CPU or GPU. | |
| Parallel_filter | GPU scans all | Haar detection, word search, audio |
| | candidates and | search. |
| | removes obvious | |
| | mismatches; CPU | |
| | more deeply | |
| | evaluates survivors | |
| | from GPU filter. | |

A heterogeneous pipeline may be implemented using the Bolt library. This pipeline mimics a traditional manufacturing assembly line. The programmer supplies a series of pipeline stages, with each stage being CPU-only, GPU-only, or CPU/GPU. Each stage processes an input token, and passes an output token to the next stage. The CPU/GPU tasks are dynamically scheduled, using the queue depth and estimated execution time to drive the scheduling decision. This arrangement permits the runtime to adapt to variations in the target hardware or system utilization and to leverage a single source code base. GPU kernels are scheduled asynchronously, such that completion invokes the next stage of the pipeline. An example pipeline as applied to video processing and rendering may be as follows:

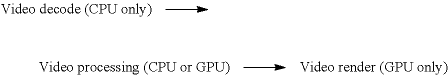

To perform the load balancing, the programmer may specify where the code is supposed to run (either on the CPU or on the GPU). This specificity may be provided with various levels of granularity, even down to an algorithm section-specific level. For example, for a ten phase algorithm, the programmer may specify that phases 1-8 run on the GPU and phases 9 and 10 run on the CPU. Such specificity would still permit a single code base to be used.

For some algorithms, the GPU may be more efficient at performing the first few stages while the CPU may be more efficient for the last few stages. Based on this knowledge, it is possible to move the transition point for where the work is handed off from the GPU to the CPU. Moving the transition point may be automated by watching utilization data for the devices in the system. For example, if the CPU is underutilized, the transition point may be moved earlier in the algorithm to hand off the work to the CPU.

One example illustrating moving the transition point is a parallel filter algorithm, which filters out a small number of results from a large initial pool of candidates. Examples of such a filter include a Haar detector, a word search, and an audio search. The initial phases of this algorithm run best on a GPU because of the large data sets (which are too large for caches), it uses a wide vector, and is high bandwidth. The tail phases of this algorithm run best on a CPU because of the smaller data sets (which may fit into a cache), the divergent control flow, and the fine-grained vector width.

The programmer specifies the execution grid (e.g., the image dimensions), the iteration state type and initial value, and the filter function. The filter function accepts a point to process and the current iteration state and returns “true” to continue processing or “false” to exit. The runtime automatically hands off the work between the GPU and the CPU and balances the work by adjusting the split point between the GPU and the CPU.

These two approaches may be combined to achieve better load balancing. In one implementation, a user of the system may make the determination of where the split point should be. In another implementation, the split point determination may be based on the existing hardware in the system. For example, a laptop computer running on battery power may have a different split point than a desktop system that is plugged in to receive power.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for performing load balancing in a heterogeneous computing system including a plurality of processing elements, the method comprising:
placing tasks into a queue by a program;
distributing a task from the queue to one of the plurality of processing elements, wherein the distributing includes:
sending a task request from the one processing element to the queue; and
sending a task to be done from the queue to the one processing element;
performing the task by the one processing element;
sending a result of the task from the one processing element to the program,
whereby the load balancing is performed by distributing tasks from the queue to processing elements that complete the tasks faster.

2. The method according to claim 1, wherein the plurality of processing elements includes one or more central processing units, one or more graphics processing units, one or more accelerated processing units, or a combination thereof.

3. The method according to claim 1, further comprising:
monitoring a utilization value of the one processing element by the program; and
distributing more tasks to the one processing element when the utilization value of the one processing element is below a threshold.

4. The method according to claim 3, wherein the threshold is determined by the program based on the tasks in the queue.

5. The method according to claim 3, wherein the threshold is determined by a user of the program.

6. The method according to claim 1, further comprising:
monitoring an energy consumption value of the one processing element by the program; and
distributing tasks to processing elements other than the one processing element when the energy consumption value of the one processing element exceeds a threshold.

7. The method according to claim 6, wherein the threshold is determined by the program based on the tasks in the queue.

8. The method according to claim 6, wherein the threshold is determined by a user of the program.

9. A heterogeneous computing system configured to perform load balancing, comprising:
a plurality of processing elements;
a queue, configured to:
hold tasks placed in the queue by a program; and
distribute a task to one of the plurality of processing elements; and
each of the plurality of processing elements is configured to:
send a task request to the queue;
receive a task to be done from the queue;
perform the task; and
send a result of the task to the program,
whereby the load balancing is performed by distributing tasks from the queue to processing elements that complete the tasks faster.

10. The heterogeneous computing system according to claim 9, wherein the plurality of processing elements includes one or more central processing units, one or more graphics processing units, one or more accelerated processing units, or a combination thereof.

11. The heterogeneous computing system according to claim 9, further comprising:
a runtime component configured to:
monitor a utilization value of the one processing element; and
indicate to the queue to distribute more tasks to the one processing element when the utilization value of the one processing element is below a threshold.

12. The heterogeneous computing system according to claim 11, wherein the threshold is determined by the runtime component based on the tasks in the queue.

13. The heterogeneous computing system according to claim 11, wherein the threshold is determined by a user of the system.

14. The heterogeneous computing system according to claim 9, further comprising:
a runtime component configured to:
monitor an energy consumption value of the one processing element; and
indicate to the queue to distribute tasks to processing elements other than the one processing element when the energy consumption value of the one processing element exceeds a threshold.

15. The heterogeneous computing system according to claim 14, wherein the threshold is determined by the runtime component based on the tasks in the queue.

16. The heterogeneous computing system according to claim 14, wherein the threshold is determined by a user of the system.

17. A method for performing load balancing in a heterogeneous computing system including a plurality of processing elements, the method comprising:
performing an algorithm of a program on a first processing element;
monitoring a utilization value of a second processing element by the program; and
performing a remaining portion of the algorithm on the second processing element when the utilization value of the second processing element is below a threshold, thereby performing load balancing.

18. The method according to claim 17, wherein the threshold is determined by the program based on a number of tasks to be performed by the program.

19. The method according to claim 17, wherein the threshold is determined by a user of the program.

20. A method for performing load balancing in a heterogeneous computing system including a plurality of processing elements, the method comprising:
performing an algorithm of a program on all of the plurality of processing elements;
monitoring an energy consumption value of each of the plurality of processing elements by the program; and
moving a remaining portion of the algorithm to different processing elements when the energy consumption value of one of the plurality of processing elements exceeds a threshold, thereby performing load balancing.

21. The method according to claim 20, wherein the threshold is determined by the program based on a number of tasks to be performed by the program.

22. The method according to claim 20, wherein the threshold is determined by a user of the program.
